(19) United States
(12) Patent Application Publication
(10) Pub. No.: US 2004/0044609 A1
(43) Pub. Date: Mar. 4, 2004

(54) System and method for providing exchange traded insurance funds

(76) Inventor: Charles Perry Moore, Lincolnshire, IL (US)

Correspondence Address: Ethan D. Civan, Dechert, 4000 Bell Atlantic Tower, 1717 Arch Street, Philadelphia, PA, 19103, US

(21) Appl. No.: 10/232,973

(22) Filed: Aug. 30, 2002

(51) Int. Cl. G06F 17/60

(52) U.S. Cl. 705/37

(57) ABSTRACT

A method of facilitating the sale of shares of exchange traded insurance funds, wherein an order to trade in shares of an exchange traded insurance fund is received from an authorized agent through an ETIF portal, the order is matched with a corresponding order, a price is determined with respect to the order, and a confirmation is provided to the authorized agent with respect to the order, wherein if the received order is an order to purchase shares, the corresponding order is an order to sell shares, wherein if the received order is an order to sell shares, the corresponding order is an order to purchase shares, and wherein the confirmation comprises at least the price.

The present invention relates to exchange traded funds.

Exchange traded funds, like conventional mutual funds, provide investors with fractional ownership interests in baskets of securities, while avoiding several of the disadvantages of mutual funds. Open end mutual funds are not traded on secondary markets; instead they issue new shares whenever investors purchase shares and reduce the number of outstanding shares whenever investors redeem shares. Open end funds determine the net asset value of their shares once daily after the close of trading. Investors purchasing shares in open end funds therefore cannot know the price of the shares until some time after an order is submitted. In a volatile market, the net asset value of an open end fund may change significantly between the time an order is submitted during a trading day and the time that it is executed after the close of trading. Moreover, because there is no secondary market, selling shares of an open end fund short is impossible. An additional potential problem is that redemptions of shares can require open end fund managers to sell securities, incurring capital gains which are passed on, in part, to the remaining shareholders.

Closed end funds, on the other hand, have fixed numbers of shares and are traded in secondary markets, but do not necessarily trade at their net asset values. In fact, closed end funds often trade at significant discounts, and on occasion at premiums, to their net asset values that often vary over time. A shareholder therefore cannot be assured of receiving the true value of his proportionate interest in the underlying securities upon selling his interest.

Exchange traded funds combine many of the advantages of both open end funds and stocks or close ended funds. Because exchange traded funds are traded in secondary markets, a shareholder can know within a very narrow variance the price of the exchange traded fund at the time of the trade, just as is the case with stocks, and can sell shares short, or place limit or stop orders to obtain a price that is no worse than a predetermined value. Furthermore, the price of an exchange traded fund is kept within a narrow range of its net asset value by permitting specialists to create new shares by contributing in kind a predetermined basket of securities of a predetermined size or to redeem shares by receiving in kind an identical basket of securities. Moreover, the tax burden on shareholders who are not selling shares is minimized by limiting the circumstances under which exchange traded funds need sell the underlying securities of the fund.

Certain insurance products, such as variable annuities and variable life insurance policies, permit customers to select investments for funds in such accounts from a set of investments offered by the particular insurer. In order to obtain the tax advantages of such insurance products, the investments offered to the customers must be limited to investments available only to customers of such insurance products. Typically, a customer is offered a choice of several mutual funds open only to investments under similar insurance products. Exchange traded funds have not been offered to such customers because they can be purchased by any investor on a secondary exchange. The present invention overcomes this and other obstacles to provide a system and method for providing exchange traded funds to customers owning such insurance products.

### SUMMARY OF THE INVENTION

In one embodiment, the invention relates to a method of facilitating the sale of shares of exchange traded insurance funds, wherein an order to trade in shares of an exchange traded insurance fund is received from an authorized agent through an ETIF portal, the order is matched with a corresponding order, a price is determined with respect to the order, and a confirmation is provided to the authorized agent with respect to the order, wherein if the received order is an order to purchase shares, the corresponding order is an order to sell shares, wherein if the received order is an order to sell shares, the corresponding order is an order to purchase shares, and wherein the confirmation comprises at least the price.

In another embodiment, the invention relates to a method of facilitating the sale of shares of exchange traded insurance funds, wherein an order to trade in shares of an exchange traded insurance fund is received from an authorized agent through an ETIF portal, the order is executed, and a confirmation is provided to the authorized agent with respect to the order, wherein the confirmation comprises at least the price at which the order was executed.

In another embodiment, the invention relates to a system for facilitating the sale of shares of exchange traded insurance funds, including means for receiving an order to trade in shares of an exchange traded insurance fund from an authorized agent through an ETIF portal, means for matching the order with a corresponding order, means for determining a price with respect to the order, and means for providing a confirmation to the authorized agent with respect to the order, wherein if the received order is an order to purchase shares, the corresponding order is an order to sell shares, wherein if the received order is an order to sell shares, the corresponding order is an order to purchase shares, and wherein the confirmation comprises at least the determined price.

In another embodiment, the invention relates to a system for facilitating the sale of shares of exchange traded insurance funds, including a first computer, including at least a processor and a memory, and a second computer, including at least a processor and a memory, in communication with the first computer, wherein an order is received by the first computer from the second computer to trade in shares of an exchange traded insurance fund through an ETIF portal, wherein the second computer is operated by an authorized agent, wherein the first computer matches the order with a corresponding order, wherein the first computer determines a price with respect to the order, wherein the first computer provides a confirmation to the second computer with respect to the order, wherein if the received order is an order to purchase shares, the corresponding order is an order to sell shares, wherein if the received order is an order to sell shares, the corresponding order is an order to purchase shares, and wherein the confirmation includes at least the determined price.

In another embodiment, the invention relates to a computer-readable medium having stored thereon computer-executable instructions for performing the following steps: receiving an order to trade in shares of an exchange traded insurance fund from an authorized agent through an ETIF portal, matching the order with a corresponding order, determining a price with respect to the order, and providing a confirmation to the authorized agent with respect to the order, wherein if the received order is an order to purchase shares, the corresponding order is an order to sell shares, wherein if the received order is an order to sell shares, the corresponding order is an order to purchase shares, and wherein the confirmation comprises at least the determined price.

In another embodiment, the invention relates to a method of facilitating the sale of shares of exchange traded insurance funds, wherein if the per share net asset value of an exchange traded insurance fund is a predetermined amount greater than the price at which it is trading on an exchange, purchasing shares of the exchange traded insurance fund from third parties and redeeming the purchased shares for the proportional share of the underlying assets of the exchange traded insurance fund represented by the redeemed shares, and if the per share net asset value of an exchange traded insurance fund is a predetermined amount less than the price at which it is trading on an exchange, contributing assets identical to the proportional share of the underlying assets of the exchange traded insurance fund represented by a number of shares in exchange for that number of shares of the exchange traded insurance fund and selling shares of the exchange traded insurance fund to third parties.

In another embodiment, the invention relates to a method of facilitating the sale of shares of exchange traded insurance funds, wherein a qualified customer is prompted to submit an order to trade in units of an exchange traded insurance fund, an order is transmitted to trade in shares of an exchange traded insurance fund relating to the received order to an exchange through a portal, a confirmation is received from the exchange if the order results in a trade, and information based on at least part of the information included in the confirmation is provided to the qualified customer.

In another embodiment, the invention relates to a method of facilitating the sale of shares of exchange traded insurance funds, wherein an order to trade in shares of an exchange traded insurance fund received from a qualified customer is transmitted to an exchange, and a confirmation relating to the order is provided to the qualified customer.

In another embodiment, the invention relates to a system for facilitating the sale of shares of exchange traded insurance funds, including means for prompting a qualified customer to submit an order to trade in shares of an exchange traded insurance fund, means for transmitting a received order to an exchange through a portal, means for receiving a confirmation from the exchange if the order results in a trade, and means for providing information based on at least part of the information included in the confirmation to the qualified customer.

In another embodiment, the invention relates to a computer-readable medium having stored thereon computer-executable instructions for performing the following steps: prompting a qualified customer to submit an order to trade in shares of an exchange traded insurance fund, transmitting a received order to an exchange through a portal, receiving a confirmation from the exchange if the order results in a trade, and providing information based on at least part of the information included in the confirmation to the qualified customer.

In another embodiment, the invention relates to a system for facilitating the sale of shares of exchange traded insurance funds, including a first computer, including at least a processor and a memory, a second computer, including at least a processor and a memory, in communication with the first computer, and a third computer, including at least a processor, a display, and an input device, in communication with the second computer, wherein the second computer is operated by an authorized agent, wherein the third computer is operated by a qualified customer, wherein a qualified customer is prompted to submit an order to trade in shares of an exchange traded insurance fund into the third computer, wherein the order is transmitted from the third computer to the second computer, wherein the order is transmitted from the second computer to the first computer, wherein the first computer transmits a confirmation to the second computer if the order results in a trade, and wherein the second computer transmits to the third computer information based on at least part of the information included in the confirmation.

In another embodiment, the invention relates to a method of facilitating the sale of shares of exchange traded insurance funds, wherein a customer is prompted to purchase a customer controlled insurance product, a customer is prompted to trade in shares of at least one exchange traded insurance fund using funds in a customer controlled insurance product, an order received from a customer to trade in shares of an exchange traded insurance fund is provided to at least one of a broker, a portal, an exchange, or a specialist, and a statement relating to the customer controlled insurance product is provided to the customer.

In another embodiment, the invention relates to a method of facilitating the sale of shares of exchange traded insurance funds, wherein an order is received to trade in shares of at least one exchange traded insurance fund using funds in a customer controlled insurance product, an order received from a customer to trade in shares of an exchange traded insurance fund is provided to at least one of a broker, a portal, an exchange, or a specialist, and a statement relating to the customer controlled insurance product is provided to the customer.

In another embodiment, the invention relates to a computer-readable medium having stored thereon computer-executable instructions for performing the following steps: prompting a customer to purchase a customer controlled insurance product, prompting a customer to trade in shares of at least one exchange traded insurance fund using funds in a customer controlled insurance product, providing an order received from a customer to trade in shares of an exchange traded insurance fund to at least one of a broker, a portal, an exchange, or a specialist, and providing a statement relating to the customer controlled insurance product to the customer.

In another embodiment, the invention relates to a system for facilitating the sale of shares of exchange traded insurance funds, including means for prompting a customer to purchase a customer controlled insurance product, means for prompting a customer to trade in shares of at least one exchange traded insurance fund using funds in a customer controlled insurance product, means for providing an order received from a customer to trade in shares of an exchange traded insurance fund to at least one of a broker, a portal, an exchange, or a specialist, and means for providing a statement relating to the customer controlled insurance product to the customer.

In another embodiment, the invention relates to a system for facilitating the sale of shares of exchange traded insurance funds, including a first computer, including at least a processor and a memory, a second computer, including at least a processor and a memory, in communication with the first computer, and a third computer, including at least a processor, a display, and an input device, in communication with the second computer, wherein a customer is prompted to purchase a customer controlled insurance product, wherein the third computer is operated by a customer, wherein a customer is prompted to enter into the third computer an order to trade in shares of at least one exchange traded insurance fund using funds in a customer controlled insurance product, wherein the order is transmitted from the third computer to the second computer, wherein the second computer is operated by an insurer, wherein the received order is transmitted to the first computer, wherein the first computer is operated by one of a broker, a portal, an exchange, or a specialist, and wherein a statement relating to the customer controlled insurance product is transmitted to the third computer.

In another embodiment, the invention relates to a method of operating a virtual private exchange within a public exchange, wherein orders are received through a predetermined portal from authorized agents to engage in transactions involving a predetermined type of security, received orders are matched with corresponding orders, matched orders are executed, and confirmations of executed orders are sent to authorized agents.

In another embodiment, the invention relates to a computer-readable medium having stored thereon a data structure relating to an order to trade in shares of an exchange traded insurance fund, including an attribute relating to the identity of an exchange traded insurance fund, an attribute relating to the number of shares of the exchange traded insurance fund to be traded, and an attribute relating to the type of trade.

In another embodiment, the invention relates to a computer-readable medium having stored thereon a data structure relating to a confirmation relating to a transaction in shares of an exchange traded insurance fund, including an attribute relating to the identity of an exchange traded insurance fund, an attribute relating to a number of shares of the exchange traded insurance fund involved in the transaction, and an attribute relating to the type of transaction.

In another embodiment, the invention relates to a method of facilitating the sale of shares of exchange traded insurance funds, wherein an order to purchase units in an exchange traded insurance fund is received from a qualified customer, shares in the exchange traded insurance fund are purchased on behalf of the qualified customer, shares held on behalf of the qualified customer are periodically sold to meet expenses relating to the exchange traded insurance fund, and the unit/share ratio is adjusted in response to each sale, wherein the number of shares purchased is determined based on a unit/share ratio in effect at the time of receipt of the order.

### BRIEF DESCRIPTION OF THE DRAWINGS

FIG. 1A illustrates a system in accordance with an embodiment of the present invention.

FIG. 1B illustrates a system in accordance with an embodiment of the present invention.

FIG. 2 illustrates a first method in accordance with an embodiment of the present invention.

FIG. 3 illustrates a second method in accordance with an embodiment of the present invention.

FIG. 4 illustrates a third method in accordance with an embodiment of the present invention.

FIG. 5 illustrates a fourth method in accordance with an embodiment of the present invention.

FIG. 6 illustrates a fifth method in accordance with an embodiment of the present invention.

FIG. 7A illustrates a first data structure usable in conjunction with an embodiment of the present invention.

FIG. 7B illustrates a second data structure usable in conjunction with an embodiment of the present invention.

FIG. 8 illustrates a sixth method in accordance with an embodiment of the present invention.

### DETAILED DESCRIPTION OF THE INVENTION

The following terms shall have, for the purposes of this application, the respective meanings set forth below.

Authorized agent: An individual or entity, such as a broker, authorized to trade in shares of an exchange traded insurance fund on behalf of qualified customers.

Custodian: An entity holding title of record to shares of an exchange traded insurance fund, the beneficial interest in which is owned by qualified customers.

Customer controlled insurance product: Any insurance product with regard to which the customer can direct the investment of funds contained in the customer's account, including, but not limited to, variable annuities and variable life insurance.

Exchange traded insurance fund (“ETIF”): A fund (i) containing a plurality of securities, (ii) which is traded on at least one exchange, (iii) ownership of which is limited to qualified customers, specialists, or fund managers, (iv) new shares of which may be obtained by contributing a specified basket of securities of a predetermined size, and (v) a predetermined number of existing shares of which may be redeemed in exchange for a specified basket of securities of a predetermined size.

ETIF Portal: A portal for receiving orders relating to exchange traded insurance funds only.

Index Fund: An open or closed end fund that seeks to replicate the performance of an index, such as the Standard & Poors 500™ or the Dow Jones Industrial Average™, either by investing the bulk of its assets in the same securities that constitute the index and in the same proportions, or by investing in a representative subset of such securities in proportions that approximate the proportions that the securities that the represented securities bear to the entire index. For example, if a security constitutes 0.2% of the index, but is deemed to be representative of a total of ten securities (including such security) that together constitute 1.9% of the index, the index fund would invest approximately 1.9% of its assets in the representative security. The index fund need not invest all of its assets in the securities comprising the index. It may retain a small percentage of its assets in cash to meet expenses and may purchase derivative securities for the purpose of better tracking the underlying index despite the retention of some cash.

Insurer: Any company offering at least one insurance product to customers.

Portal: A conduit for receiving a class of orders, such as all orders relating to stocks, all orders relating to options, or all orders relating to exchange traded insurance funds.

Qualified customer: The owner of a customer controlled insurance product.

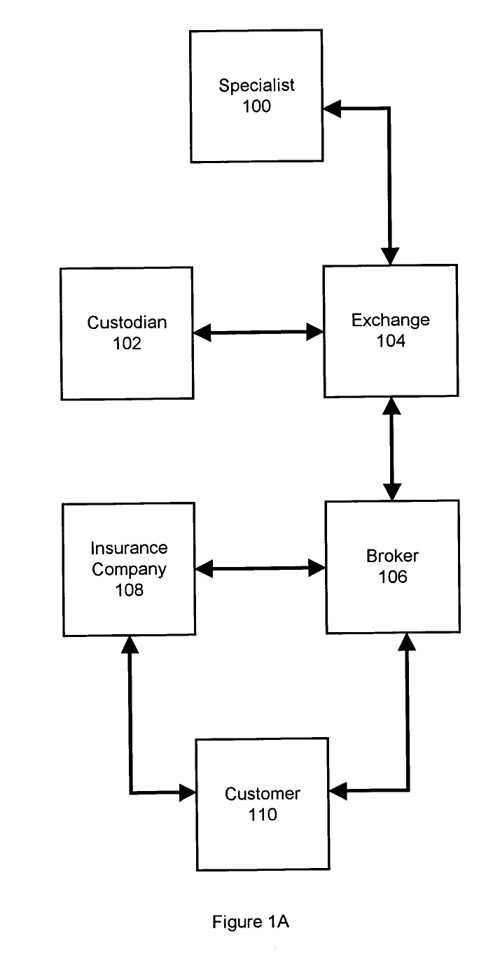

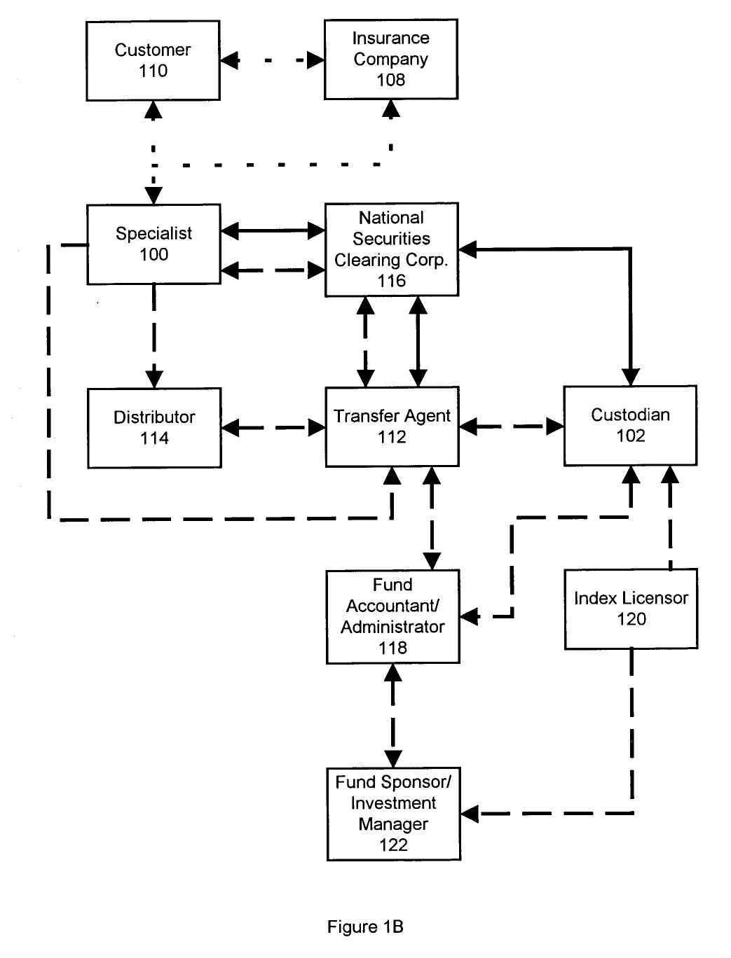

Referring to FIG. 1A, a system in accordance with the present invention is illustrated. A customer 110 purchases a customer controlled insurance product from insurer 108 over the Internet, by postal mail, in person, or otherwise. Customer 110 may utilize a computer to send investment instructions to either broker 106 (which is an authorized agent) or insurer 108 in different embodiments of the present invention. The customer's computer (if the customer utilizes one) can be any computing device capable of sending investment directions to a broker or insurer, such as a personal computer (such as a Pentium class Windows PC), a personal digital assistant, an Internet appliance, a smart telephone, or a dumb terminal. Such instructions can be sent over ordinary telephone lines, the Internet, or a private network. In one embodiment, an Internet stockbroker maintains a Web site or portion thereof similar to its Web site (which may be located at the broker, the insurer, or a third location) for customers other than qualified customers, including screens for entering orders, viewing balances and holdings (including current market value, preferably on a substantially real time basis), obtaining quotes, and viewing pending and executed transactions, but with the differences that only funds and assets contained in customer controlled insurance product accounts are viewable or accessible and that only securities eligible for purchase with customer controlled insurance product funds are displayed or accessible. Alternatively, instructions may be sent to the insurer or broker by other means, such as by telephone. If the instructions are sent to the insurer, the insurer forwards them to the broker, by computer or human means.

Exchange 104 may be any existing or future stock exchange. Exchange 104 may execute transactions using human traders or a computerized crossing network. In one embodiment, exchange 104 includes a plurality of portals, of which only one accepts transactions relating to exchange traded insurance funds. Preferably, such portal accepts transactions from authorized agents and specialists only. In a particular embodiment, there may be one or more authorized agents, which are brokers that have set up safeguards to ensure that only qualified customers submit orders relating to exchange traded insurance funds.

Title to all shares of each exchange traded insurance fund is held by custodian 102 in one embodiment of the present invention for administrative simplicity. In other embodiments, custodian 102 can be omitted. In embodiments in which custodian 102 is present, custodian 102 receives notification of each transfer of shares of any exchange traded insurance fund and updates its records accordingly.

Specialist 100 helps keep the current price of an exchange traded insurance fund close to its net asset value. One or more specialists can be utilized in accordance with the present invention. In some embodiments specialist 100 is a human, or a company represented by a human agent; in other embodiments, specialist 100 can be represented by a computerized system, such as the American Stock Exchange's Automatch system. Whenever the net asset value is more than a small amount less than the price of a share (that is to say that the exchange traded insurance fund is trading at more than a slight premium to net asset value), the specialist contributes a basket of securities in the total amount of a creation unit in exchange for a proportional number of shares of the fund and sells the newly created shares on the exchange until the net asset value is equal to the current price. A creation unit is typically a large number of shares of an exchange traded insurance fund, such as fifty thousand shares, or a number of shares with a large dollar value, such as five million dollars. Conversely, whenever the net asset value is more than a small amount more than the price of a share (that is to say that the exchange traded insurance fund is trading at more than a slight discount to net asset value), the specialist buys shares of the fund on the exchange and redeems a number of shares in the amount of a creation unit in exchange for a basket of securities until the net asset value is equal to the current price. Although the specialist is not expected to be a qualified customer, it is anticipated that the transitory ownership of shares by the specialist for the purpose of stabilizing share prices will not result in any adverse tax consequences to an exchange traded insurance fund.

In the case of an exchange traded insurance fund that is an index fund (which exchange traded funds have historically been), the basket of securities is the securities in the underlying index in the proportions in which the index is composed and in a predetermined amount set equal to one creation unit. In the case of an exchange traded insurance fund that is not an index fund, the securities owned by the fund can be disclosed a short period of time in advance of the effective time at which such basket will be effective. In one embodiment of the present invention, the securities owned by an exchange traded insurance fund that is not an index fund are tracked by a computer operated by the fund investment advisor and the fund's positions are downloaded in real time to a computer at specialist 100, which computer automatically determines periodically (such as once a minute), the composition of the securities and cash that underlie one creation unit's worth of shares of the fund and the amount (in currency or percentage terms) of the discount or premium of the current price of an equivalent number of shares to net asset value. The specialist's computer can then either execute appropriate transactions whenever the discount or premium exceeds a predetermined amount, or notify a human that the discount or premium exceeds a predetermined amount and recommend that the transactions be carried out. The predetermined amount can be the total transaction cost of carrying out each necessary transaction.

In each of the above embodiments, all communications between the above parties, if performed by computer, are preferably encrypted, using secure socket layer or other technology. In any event, passwords or other information verifying parties' identities are preferably required.

Referring to FIG. 1B, a system in accordance with an exemplary embodiment of the present invention is illustrated. In FIG. 1B, solid lines denote the movement of one or more of cash, exchange traded insurance fund shares, and shares of underlying securities owned (or to be owned) by an exchange traded insurance fund. Dashed lines with long dashes denote the transmission of one or more of orders, instructions, and reports. Dashed lines with short dashes denote the optional transmission of one or more of orders, instructions and reports.

In certain embodiments hereunder, either customer 110, insurance company 108, or both customer 110 and insurance company 108 from time to time transmit orders to trade in shares of exchange traded insurance funds to specialist 100. Customer 110 is a qualified customer using funds or securities held in an insurance product to consummate transactions in exchange traded insurance funds. In some such embodiments, customer 110 transmits orders directly to specialist 100 over the Internet or by other means (such as by telephone). In other embodiments, customer 110 transmits orders to insurance company 108 over the Internet, by telephone, or by other means and insurance company 108 subsequently transmits such instructions over the Internet, by telephone, or by other means to specialist 100. In some of such other embodiments, the transmission of orders from insurance company 108 is required to comply with regulatory requirements.

Specialist 100 serves two primary functions, facilitating trades of existing shares of exchange traded insurance funds among qualified customers and from time to time creating or redeeming creation lots of shares to be sold to qualified customers or bought from qualified customers on its own account. Specialist 100 is the only entity other than a qualified customer or the fund manager permitted to hold a beneficial interest in shares of an exchange traded insurance fund. In the exemplary embodiment, there is only one specialist 100 with respect to any particular exchange traded insurance fund, but in other embodiments, multiple specialists can function with respect to a single exchange traded insurance fund.

In the exemplary embodiment, National Securities Clearing Corporation 116 accommodates the clearance and settlement of exchange traded insurance fund transactions, disseminates the list of component securities in an exchange traded insurance fund, accepts creation and redemption orders from specialist 100 and executes the transactions with respect to the underlying securities owned by the exchange traded insurance fund necessary to consummate such accepts creation and redemption orders, disseminates the details of creation and redemption orders to concerned parties, and guarantees cash settlement amounts (excluding transaction fees).

Distributor 114 accepts and approves creation and redemption orders. Transfer Agent 112 maintains records relating to the ownership of shares in exchange traded insurance funds, maintains records relating to the number of outstanding shares in exchange traded insurance funds, reconciles outstanding receipts and balances with the depository, and serves as the paying agent for fund distributions. Custodian 102 holds and maintains the assets of an exchange traded insurance fund, is responsible for trade settlement relating to the creation or redemption of shares of an exchange traded insurance fund and the assets underlying that fund, and facilitates movement of creation and redemption trades to the clearing agent or depository.

In certain embodiments of the present invention, an Identity Verification Custodian (not shown) performs due diligence to verify that a customer in a transaction is a qualified customer. Such due diligence can comprise more than merely verifying a username and password. For example, the Identity Verification Custodian can send an automated message regarding each transaction to the appropriate insurance company and hold all assets to be received by the customer's account in escrow until the customer's identity is verified by the insurance company or until a predetermined amount of time has elapsed. No Identity Verification Custodian is present in the exemplary embodiment.

Fund Accountant/Administrator 118 values all assets held by an exchange traded insurance fund and determines its net asset value periodically (such as daily) and tracks and reports on cash transactions (such as payment of expenses and dividends). Index Licensor 120 constructs, calculates, and revises official index data and distributes index weightings and management information to the investment manager. Fund Sponsor/Investment Manager 122 determines the basket or index to be used by the exchange traded insurance fund, periodically rebalances its portfolio in accordance with such basket or index, markets the exchange traded insurance fund, and performs administrative duties.

In other embodiments of the present invention, a greater or lesser number of entities can divide the above responsibilities differently and a change in the number of entities in a particular embodiment may necessitate the performance of additional duties or obviate the performance of duties described above. In addition, depending on the prevailing legal requirements for transactions in shares of exchange traded insurance funds, certain of the above responsibilities and entities may be dispensed with or additional responsibilities or entities may become necessary. Those skilled in the art will further appreciate that based on the assets that will be held by an exchange traded insurance fund (such as foreign securities or tangible assets) and the type of exchange traded insurance fund (such as actively managed), additional or different responsibilities and entities may be needed or desirable.

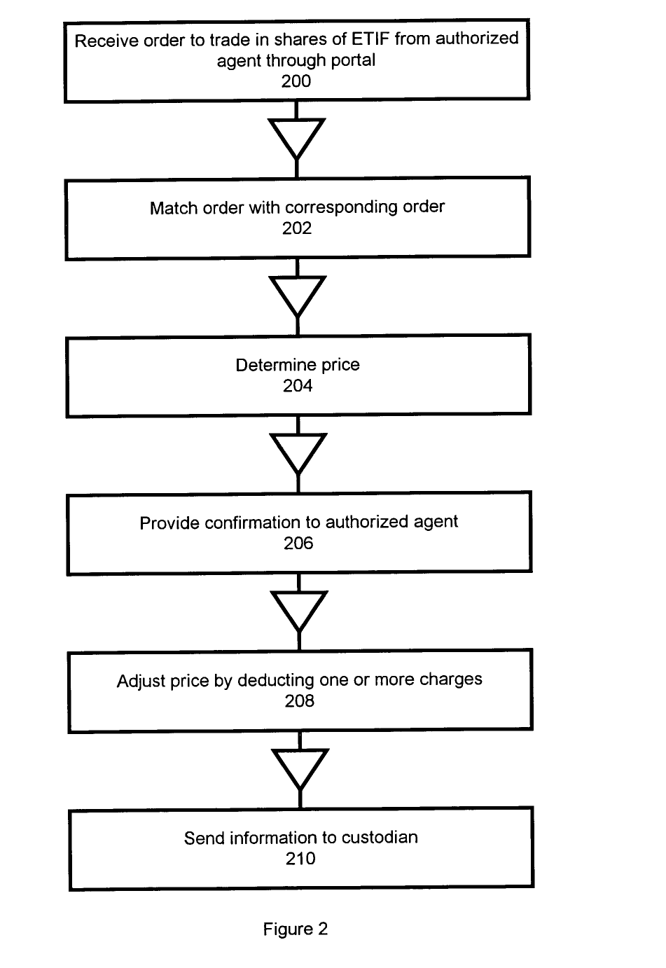

Referring to FIG. 2, a first method in accordance with an embodiment of the present invention is illustrated. In step 200, an order is received at an exchange to trade in shares of an exchange traded insurance fund from an authorized agent through a portal. The exchange traded fund can be structured as a unit investment trust or as an open or closed end mutual fund and can be an index fund or an actively managed fund. (An actively managed exchange traded insurance fund may need publicly to disclose its positions in advance of acquiring them to allow a specialist or other arbitrageur to minimize divergences between the net asset value and current share price as described above.) Moreover, in some embodiments hereunder, a particular fund can be available for purchase by qualified customers of one or more insurers and of one or more different varieties of customer controlled insurance products, such as variable annuities and variable life insurance. In some embodiments of the present invention, the authorized agent is a broker, such as an Internet stockbroker, but in other embodiments, the authorized agent can be another entity, such as an insurance company, if permitted by rules of the relevant exchange. The order can be any order permitted on the relevant exchange, including an order to purchase or sell any whole or fractional number of shares at market, a stop or limit order, an order good for a single day or good until canceled, and an order that may be filled in part or only in totality if at all. In certain embodiments, the order is transmitted to the exchange electronically by the authorized agent over the Internet or a private network, preferably using encryption, such as secure socket layer encryption. In other embodiments, the order is transmitted by telephonic or other means to the exchange. In either case, the order is received at the exchange by a portal dedicated to exchange traded insurance funds, or dedicated to a subset of one or more exchange traded insurance funds, or dedicated to securities eligible for holding in customer controlled insurance products. The portal preferably verifies that the order was transmitted by an authorized agent that previously entered into agreements and established procedures sufficient to ensure that orders are submitted on behalf of qualified customers only. The portal can be a computer that verifies the identity of the sender of an order using an encryption algorithm. In embodiments in which many authorized agents exist, the identities of the authorized agents can be stored in a database or other file in a computer memory. In other embodiments, only a few, or even only one, authorized agent may exist, and the identity or identities of such authorized agent or agents can be hard-coded into an executable file.

In step 202, the order is matched with a corresponding order. If the order is a purchase, the order is matched with a sell order for the same exchange traded insurance fund. Conversely, if the order is a sale, the order is matched with a purchase order for the same exchange traded insurance fund. Depending on the rules and procedures of the exchange, the order can be matched in a variety of ways. The order can be matched by allowing other brokers to accept or reject it, by offering it to a specialist for acceptance or rejection, by storing it in a computer with all other currently pending orders and matching the orders using an algorithm (such as matching orders on a first come first served basis so long as the terms of the orders do not conflict, e.g., partially filling an order by matching an earlier smaller order with it rather than matching it with a later order of the same size), or by other means. In certain embodiments, unmatched orders are stored until their expiration to allow later matching attempts with later received orders.

In step 204, a price is determined if the order is successfully matched using the rules of the exchange. Typically, the price is the market price at the moment that the order is matched, but other pricing methods or algorithms for determining a price are possible, as is well known in the art. For example, in some embodiments, the price charged to a purchaser can be different from the price credited to the seller due to a bid/ask spread.

In other embodiments of the present invention, instead of determining a price based on the prices bid and asked for the exchange traded insurance fund, the price can be determined by calculating the net asset value of the fund at the moment that an order is matched, particularly where the fund is based on an index. Because the formula for determining the net asset value of an index is known in advance, a computer at the exchange can feed the most recent prices for the underlying securities into the formula and determine a net asset value for the fund with a minimal delay.

In certain embodiments of the present invention, step 204 can be combined with step 202. Moreover, steps 202 and 204 can be performed in any order.

In step 206, a confirmation is provided to the authorized agent with respect to the order if the order was matched. The confirmation can be provided using the same channel of communication by which the order was provided to the exchange. The confirmation preferably includes at least the price at which the order was matched and may also include other information, such as information relating to any one or more of an order number, a confirmation number, the identity of the authorized agent, the identity of a customer controlled insurance product, the identity of the customer's account, the result of the order (such as completely filled, partially filled, pending, or failure), the exchange traded insurance fund that is the subject of the order, the number of shares traded, and the date and time of execution. Preferably, a confirmation is provided if the order is not matched, or is not matched within a predetermined period.

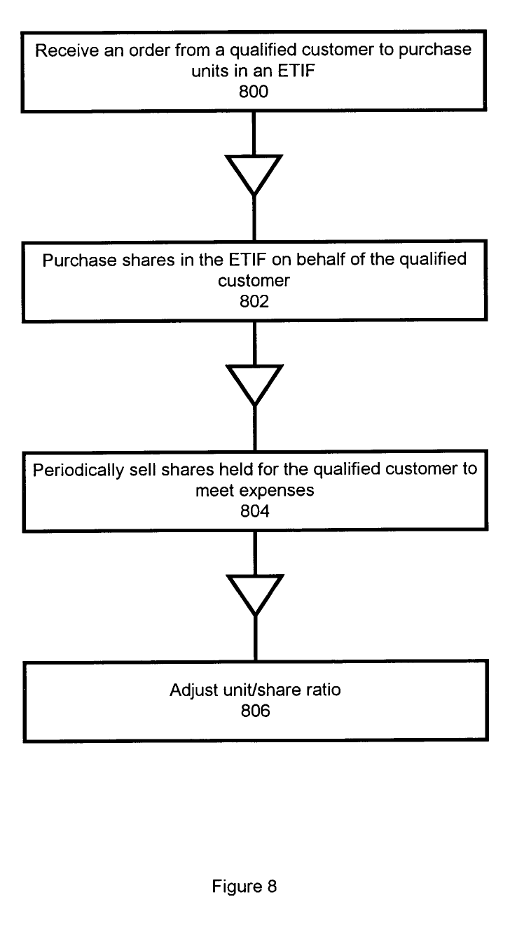

In step 208, in certain embodiments, the price is adjusted at the time of sale to reflect daily mortality charges due with respect to the customer controlled insurance product relating to the order. The exchange can store a table of mortality charges relating to different insurance products and the order can include the identity of the relevant insurance product, or a table of mortality charges can be maintained by the authorized agent and the mortality charge can be transmitted to the exchange as part of the order. In other embodiments, all mortality adjustments are performed by the insurer or authorized agent on a periodic basis, such as at the close of each day. In certain embodiments, the price is also or instead similarly adjusted with respect to operating expenses of the exchange traded insurance fund. In other embodiments, all such adjustments are performed by the insurer or authorized agent on a periodic basis, such as at the close of each day. Performing the adjustments at the close of each day simplifies the task of ensuring that mortality charges are imposed against each share on an equal basis. For example, if it is desired to impose mortality charges equally against each share on a daily basis, imposing the charges at the time of sale could lead to a share that is traded multiple times on a single day bearing multiple mortality charges. If the charges are imposed at the end of each day, this problem does not arise. Step 208 is omitted in some embodiments and can be combined with step 204 in others. In yet other embodiments, such as in the method illustrated in FIG. 8, share prices can be kept constant while the number of shares owned by or on behalf of a customer is altered to reflect one or more of operating and mortality charges.

In step 210, in certain embodiments, a custodian is sent information relating to each order that is successfully matched to allow it to adjust its records of the beneficial ownership of the outstanding shares of the exchange traded insurance fund to reflect the execution of the applicable transaction. This information includes at least the number of shares transferred and information relating to the identities of the purchaser and seller (or their accounts) and of the security that is the subject of the transaction. Optionally, the information can include one or more of the date and time of the transaction and information relating to the identity of the authorized agent, the insurer, or the customer controlled insurance product. In other embodiments, no custodian is present and step 210 is omitted.

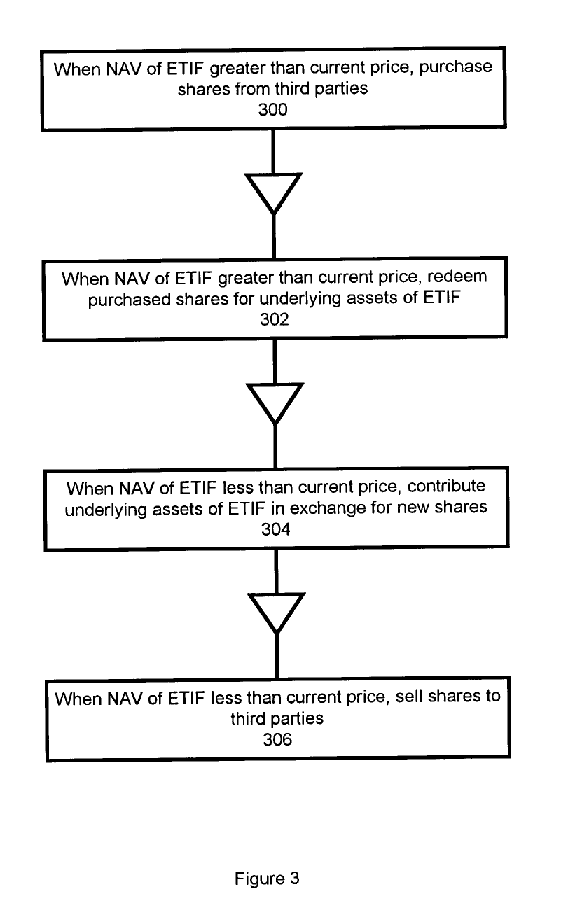

Referring to FIG. 3, a second method in accordance with an embodiment of the present invention is illustrated. In step 300, if the per share net asset value of an exchange traded insurance fund is greater than the price at which it is trading on an exchange, a specialist for that exchange traded insurance fund purchases shares of the fund from third parties on the exchange. In step 302, the specialist then redeems the purchased shares for the proportional share of the underlying assets of the exchange traded insurance fund represented by the redeemed shares. The specialist can then realize a profit by immediately selling the assets received in the redemption. By reducing the supply of available shares of the exchange traded insurance fund, the specialist tends to increase the price of the fund until it approaches net asset value. Steps 300 and 302 can be performed in any order or simultaneously and can be performed repeatedly.

In step 304, if the per share net asset value of the exchange traded insurance fund is less than the price at which it is trading on an exchange, the specialist contributes assets identical to the proportional share of the underlying assets of the exchange traded insurance fund represented by a number of shares equal to one creation lot in exchange for a number of shares of the exchange traded insurance fund equal to one creation lot. In step 306, the specialist sells some or all of a creation lot of shares of the fund to third parties on the exchange. By increasing the supply of available shares of the exchange traded insurance fund, the specialist tends to decrease the price of the fund until it approaches net asset value. Steps 304 and 306 can be performed in any order or simultaneously and can be performed repeatedly.

Preferably, the specialist only performs the steps of the method illustrated in FIG. 3 when the price of the exchange traded insurance fund varies from net asset value by more than the transaction costs that would be incurred in carrying out the steps of that method.

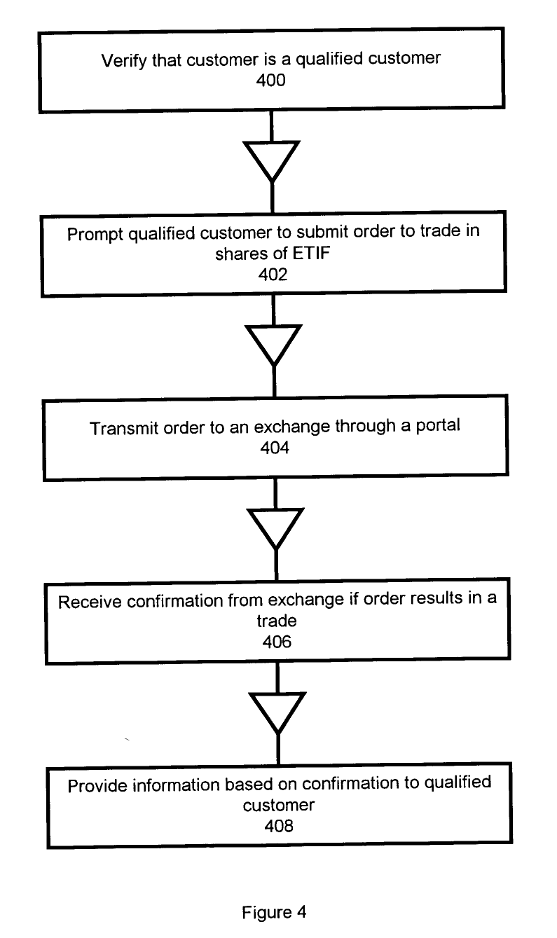

Referring to FIG. 4, a third method in accordance with an embodiment of the present invention is illustrated. In step 400, a broker confirms that a customer is a qualified customer (or acting on behalf of a qualified customer). The broker may provide a Web site for placing orders relating to exchange traded insurance funds over the Internet in the same fashion that online brokers, such as e-Trade, and Charles Schwab, provide Web sites for placing orders relating to stocks, mutual funds, exchange traded funds, and other securities over the Internet currently, with the exception that all orders must relate to customer controlled insurance product accounts and to securities eligible for ownership in such accounts. The broker may confirm the status of the customer by comparing information submitted by the customer, such as a username or taxpayer identification number and password with information previously received from an insurer (such as a list of qualified customers of that insurer together with such identifying information).

In step 402, the qualified customer is prompted to submit an order to trade in shares of an exchange traded insurance fund. The qualified customer can be so prompted by providing such customer with the capability to access screens showing a list of his current positions and their market values, his current cash balances in the fund, a list of investments eligible for purchase in the customer controlled insurance fund, and a set of data entry fields for entering a transaction. After completing the necessary fields, such as type of transaction, fund to be traded, and share amount (and optionally other transaction parameters), the customer can then transmit an order to the broker by clicking a command button or otherwise.

In step 404, the broker transmits the order received from the customer to an exchange through a portal. Preferably, the broker first verifies that the transaction is appropriate (e.g., the customer has adequate equity in the account) either manually or automatically. As described above in connection with step 200, the order can be sent over the Internet, a private network, by telephone, mail, or other electronic or conventional means to a portal at an exchange and if electronic means are utilized, each transmission is preferably encrypted. In certain embodiments of the present invention, a particular exchange traded insurance fund will be traded at only one exchange and all transactions relating to the exchange traded insurance fund will be submitted through a single portal.

If the order results in a trade, or optionally even if it does not, a confirmation is received from the exchange as described above in connection with step 206. In step 408, some or all of the information provided by the exchange in a confirmation is provided to the customer. In the case of an online broker, the information can be provided in tabular form in a screen listing all executed transactions. Notification by postal mail, e-mail, facsimile or other means is also possible.

Notwithstanding the above description, the method illustrated in FIG. 4 need not be performed over the Internet. It can also be performed using direct telephonic connections between computers, on-site kiosks and dedicated private networks, or by mail, telephone, or other means.

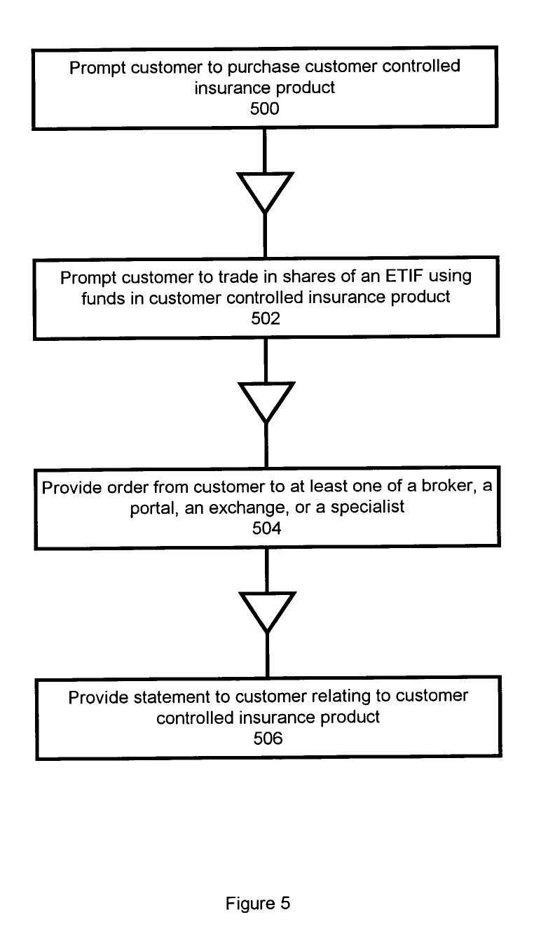

Referring to FIG. 5, a fourth method in accordance with an embodiment of the present invention is illustrated. In step 500, a customer is prompted to purchase a customer controlled insurance product, such as a variable annuity or policy of variable life insurance. The customer can be so prompted by an insurer or other party by electronic, telephonic, postal, or other means.

In step 502, the customer is prompted by an insurer, broker, or other party to trade in shares of at least one exchange traded insurance fund using funds contained in a customer controlled insurance product account purchased in response to step 500. The customer can be so prompted over the Internet (or otherwise by computer) as described in step 402, by postal mail, by e-mail, by telephone, in person, or by other means.

In step 504, an order received from a customer in response to step 502 is provided to at least one of a broker, a portal, an exchange, or a specialist. If the order is received by a party other than a broker (such as by an insurer), exchange rules may require that the order be forwarded to a broker before it can be executed. If the order is received by a broker, the broker in certain embodiments of the present invention forwards the order to an exchange through a portal, as described in step 404. In certain embodiments of the present invention, a broker instead, or alternately at his option, forwards the order to an exchange through other channels or forwards it directly to a specialist, through electronic or conventional means.

In step 506, an electronic or paper statement relating to the customer controlled insurance product account is provided to the customer. The statement can be provided on a fixed periodic basis, after the execution of a security transaction, at the request of the customer, or on any other schedule. The statement can include the value and current benefits of the customer controlled insurance product account, as well as the securities currently held in the account and the market values of such securities.

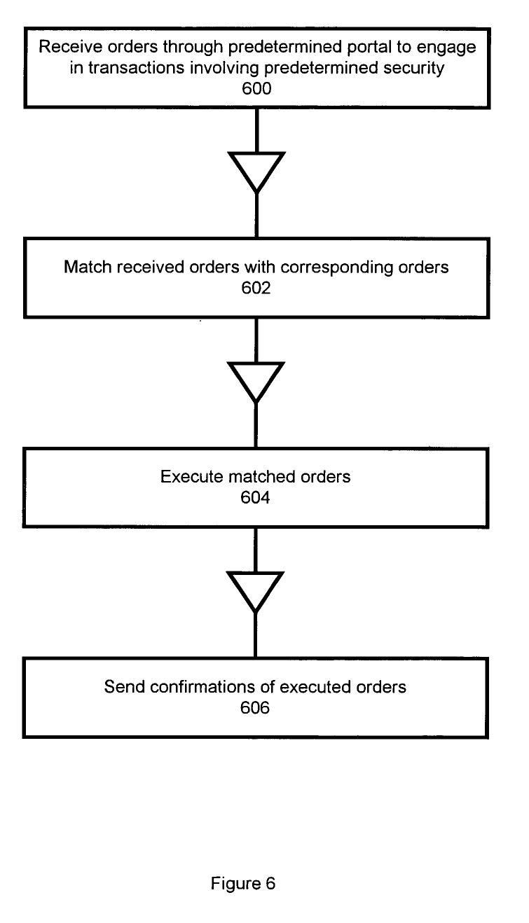

Referring to FIG. 6, a fifth method in accordance with an embodiment of the present invention is illustrated. In step 600, orders are received through a predetermined portal from authorized agents or other preauthorized brokers or other parties to engage in transactions involving a predetermined security. The security can, but need not, be an exchange traded insurance fund in any particular embodiment of the present invention. The preauthorization of the agents or other parties and the use of the predetermined portal, which is preferably not used for transactions in other classes of securities, allows a public exchange to be operated as a private exchange for a subset of the investing public, such as qualified customers.

In step 602, received orders are matched with corresponding orders as in step 202 described in connection with the method illustrated in FIG. 2. In step 604, matched orders are executed by making appropriate database or paper entries, debiting or crediting accounts, or by other means. In step 606, confirmations of executed orders are sent to the authorized agents or other parties who originally transmitted the orders to the exchange.

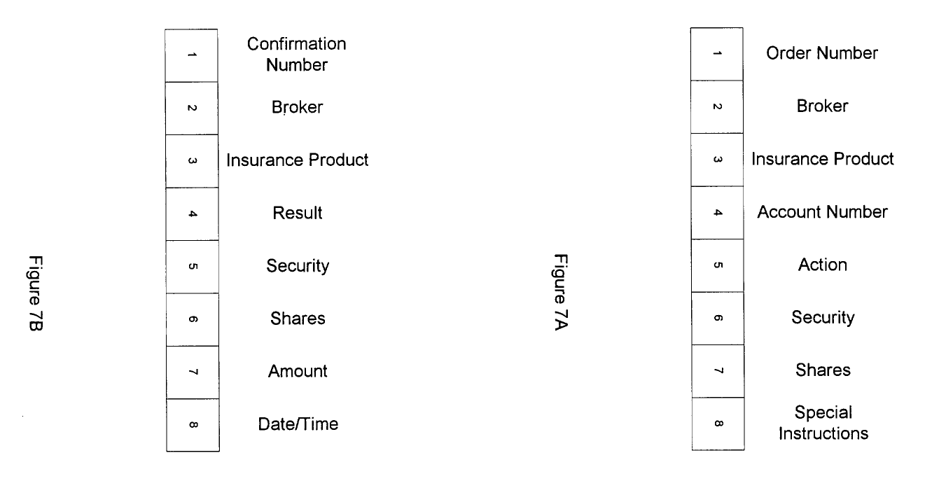

FIG. 7A illustrates an exemplary data structure in which an order relating to an exchange traded insurance fund can be stored. The data structure can be an object or a record in a relational database, flat file, or other file. The exemplary data structure includes an order number field, a field containing either the identity of a broker or a code or pointer enabling such identity to be retrieved, a field containing either the identity of an insurance product or a code or pointer enabling such identity to be retrieved, a field containing either the identity of an account or a code or pointer enabling such identity to be retrieved, a field containing either an action to be performed (such as a purchase or sale) or a code or pointer enabling such action to be retrieved, a field containing either the identity of an exchange traded insurance fund or a code or pointer enabling such identity to be retrieved, a field containing a number of shares to be traded, and a field allowing special instructions (such as a stop or limit price) to be included or retrieved.

FIG. 7B illustrates an exemplary data structure in which a confirmation relating to a trade of an exchange traded insurance fund can be stored. The data structure can be an object or a record in a relational database, flat file, or other file. The exemplary data structure includes a confirmation number field, a field containing either the identity of a broker or a code or pointer enabling such identity to be retrieved, a field containing either the identity of an insurance product or a code or pointer enabling such identity to be retrieved, a field containing either the identity of an account or a code or pointer enabling such identity to be retrieved, a field containing either the identity of an exchange traded insurance fund or a code or pointer enabling such identity to be retrieved, a field containing a number of shares traded, a field containing a currency amount relating to the trade and a field containing the date and optionally the time of the execution of the transaction.

FIG. 8 illustrates a sixth method in accordance with an embodiment of the present invention, which can be used in conjunction with the methods described above in connection with FIGS. 2 through 6. In step 800, an order to purchase units in an exchange traded insurance fund is received from a qualified customer. Prior to the performance of step 800, the qualified customer can be prompted to purchase such units by a broker, such as an internet broker, that is an authorized agent, directly by the insurer from which the qualified customer has purchased an insurance product, or otherwise. Each unit represents an ownership interest in one, more than one, or a fraction of one share of an exchange traded insurance fund. In a particularly preferred embodiment, each unit represents ownership of a fraction of one share of the exchange traded insurance fund and that fraction decreases over time as described below.

In step 802, shares are bought on an exchange or otherwise on behalf of the qualified customer in the exchange traded insurance fund for which the qualified customer submitted an order to purchase units. The number of shares purchased in step 802 is the number of units ordered by the customer divided by a unit/share ratio then in effect. The unit/share ratio can be different for each separate exchange traded insurance fund, can be different for each separate insurance product, funds invested in which are used to purchase exchange traded insurance funds, and can vary over time.

In an exemplary embodiment, the price at which units are offered to customers at the beginning of a trading day is determined using the following formula:

Offer Unit Price=PriorDayOffer Unit Price×

$$\begin{matrix}OfferUnitPrice = PriorDayOfferUnitPrice \times \\ ( \frac{CurrentDayOffer + Di vidends}{PriorDayOffer} - \frac{Mortality + Expense}{DaysInYear} )\end{matrix}$$

where PriorDayOfferUnitPrice is the offer price for units determined for the previous day (or the net asset value or other value for the first day on which the exchange traded insurance fund is traded), CurrentDayOffer is the exchange traded insurance fund's current offer price (which can be the current net asset value plus a predetermined amount or percentage, thereby creating a spread between bid and offer prices similar to a spread that might exist with respect to shares of a stock), PriorDayOffer is the CurrentDayOffer determined on the previous trading day, Dividends are the sum of per share dividends payable to shareholders of record as of the current day, Mortality is the mortality charge imposed by the insurer with respect to a particular insurance product over the course of a year expressed as a percentage of fund assets, Expense is the exchange traded insurance fund's expense ratio, and DaysInYear is the number of days in the current year.

Similarly, the price at which units are purchased from customers at the beginning of a trading day is determined using the following formula:

SaleUnitPrice=PriorDaySaleUnitPrice×

$$\begin{matrix}SaleUnitPrice = PriorDaySaleUnitPrice \times \\ ( \frac{CurrentDayNAV + Di vidends}{PriorDayNAV} - \frac{Mortality + Expense}{DaysInYear} )\end{matrix}$$

where PriorDaySaleUnitPrice is the sale price for units determined for the previous day (or the net asset value or other value for the first day on which the exchange traded insurance fund is traded), CurrentDayNAV is the exchange traded insurance fund's current net asset value (determined based on assets values as of the close of the previous trading day), PriorDayNAV is the CurrentDayNAV determined on the previous trading day, Dividends are the sum of per share dividends payable to shareholders of record as of the current day, Mortality is the mortality charge imposed by the insurer with respect to a particular insurance product over the course of a year expressed as a percentage of fund assets, Expense is the exchange traded insurance fund's expense ratio, and DaysInYear is the number of days in the current year.

After the commencement of trading on a particular trading day, the offer unit price and the sale unit price can both be allowed to fluctuate based at least in part on orders received, or one of the offer unit price and the sale unit price can be allowed so to fluctuate while the other is set an amount or percentage higher or lower so as to create a spread.

In this exemplary embodiment, the unit/share ratio can be determined at the beginning of a trading day by dividing the unit sale price by the current net asset value. That unit/share ratio would be in effect for the duration of the trading day.

In other embodiments, the mortality or expense ratios, or both, can be taken into account in calculating the net asset value of an exchange traded insurance fund, simplifying sale and offer unit price calculations. In yet other embodiments, average or typical mortality or expense ratios, or both can be taken into account in calculating the net asset value of an exchange traded insurance fund and any differences from those average or typical ratios can be adjusted using formulae similar to the above formulae. In still other embodiments, expense charges can be imposed less frequently than daily or at irregular intervals.

In step 804, shares, but not units, are periodically sold to pay expenses relating to the exchange traded insurance fund, such as mortality or expense ratios.

The implementation of certain embodiments of the present invention is illustrated in greater detail in Appendix A. Under present law it is necessary to gain certain exemptive relief from the Securities and Exchange Commission and from the Internal Revenue Service prior to public use of an implementation of the present invention. Appendix A also illustrates this process.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

That which is claimed is:

1. A method of facilitating the sale of shares of exchange traded insurance funds, comprising:
(a) receiving an order to trade in shares of an exchange traded insurance fund from an authorized agent through an ETIF portal;
(b) matching the order with a corresponding order;
(c) determining a price with respect to the order; and
(d) providing a confirmation to the authorized agent with respect to the order,
wherein if the order received in step (a) is an order to purchase shares, the corresponding order in step (b) is an order to sell shares;
wherein if the order received in step (a) is an order to sell shares, the corresponding order in step (b) is an order to purchase shares; and
wherein the confirmation comprises at least the price determined in step (c).

2. The method of claim 1, wherein the exchange traded insurance fund is an index fund.

3. The method of claim 2, wherein the order relates to an instruction from a qualified customer to purchase units of the exchange traded insurance fund.

4. The method of claim 2, wherein the order comprises at least an identifier specifying a customer account, an identifier specifying an exchange traded insurance fund, an identifier specifying an order type, and a quantity of shares.

5. The method of claim 2, wherein the price determined in step (c) is based at least in part on the net asset value of the underlying securities owned by the exchange traded insurance fund.

6. The method of claim 2, wherein the price determined in step (c) is based at least in part on the terms of the order and the corresponding order.

7. The method of claim 2, wherein the price determined in step (c) is based at least in part on the price at which shares of the exchange traded insurance fund were traded in at least one previous trade.

8. The method of claim 2, wherein the price determined in step (c) is net of a mortality charge.

9. The method of claim 2, wherein the price determined in step (c) is net of an operating expense charge.

10. The method of claim 2, further comprising:
(e) adjusting the price determined in step (c) by deducting one or more charges, including at least a mortality charge.

11. The method of claim 2, wherein the order relates to funds contained in a customer controlled insurance product.

12. The method of claim 11, wherein the customer controlled insurance product is a variable annuity.

13. The method of claim 11, wherein the customer controlled insurance product is a variable life insurance policy.

14. The method of claim 2, wherein the exchange traded fund is an open end fund.

15. The method of claim 2, wherein the exchange traded fund is a close ended fund.

16. The method of claim 2, wherein the exchange traded fund is a unit investment trust.

17. The method of claim 2, wherein the exchange traded fund is an index fund.

18. The method of claim 2, wherein the exchange traded fund is an actively managed fund.

19. The method of claim 2, further comprising:
(e) sending to a custodian information relating to the order.

20. The method of claim 19, wherein the information sent in step (e) includes at least information relating to the number of shares to which the order relates, information relating to the identity of the owner of such shares prior to the execution of such order, and information relating to the identity of the owner of such shares following the execution of such order.

21. The method of claim 1, wherein the exchange traded insurance fund is an actively managed fund.

22. A method of facilitating the sale of shares of exchange traded insurance funds, comprising steps for:
(a) receiving an order to trade in shares of an exchange traded insurance fund from an authorized agent through an ETIF portal;
(b) executing the order; and
(c) providing a confirmation to the authorized agent with respect to the order,
wherein the confirmation comprises at least the price at which the order was executed in step (b).

23. The method of claim 22, wherein the exchange traded insurance fund is an index fund.

24. The method of claim 22, wherein the exchange traded insurance fund is an actively managed fund.

25. A system for facilitating the sale of shares of exchange traded insurance funds, comprising:
means for receiving an order to trade in shares of an exchange traded insurance fund from an authorized agent through an ETIF portal;
means for matching the order with a corresponding order;
means for determining a price with respect to the order; and
means for providing a confirmation to the authorized agent with respect to the order,
wherein if the received order is an order to purchase shares, the corresponding order is an order to sell shares;
wherein if the received order is an order to sell shares, the corresponding order is an order to purchase shares; and
wherein the confirmation comprises at least the determined price.

26. The system of claim 25, wherein the exchange traded insurance fund is an index fund.

27. The system of claim 25, wherein the exchange traded insurance fund is an actively managed fund.

28. A system for facilitating the sale of shares of exchange traded insurance funds, comprising:
a first computer, comprising at least a processor and a memory; and
a second computer, comprising at least a processor and a memory, in communication with said first computer,
wherein an order is received by said first computer from said second computer to trade in shares of an exchange traded insurance fund through an ETIF portal;
wherein said second computer is operated by an authorized agent;
wherein said first computer matches the order with a corresponding order;
wherein said first computer determines a price with respect to the order;
wherein said first computer provides a confirmation to said second computer with respect to the order;
wherein if the received order is an order to purchase shares, the corresponding order is an order to sell shares;
wherein if the received order is an order to sell shares, the corresponding order is an order to purchase shares; and
wherein the confirmation comprises at least the determined price.

29. The system of claim 28, wherein the exchange traded insurance fund is an index fund.

30. The system of claim 29, further comprising:
a third computer, comprising at least a processor, a display, and an input device, in communication with said second computer,
wherein said third computer is operated by a customer;
wherein the customer enters an order relating to an exchange traded insurance fund into said third computer;
wherein the entered order relates to assets contained in a customer controlled insurance product; and
wherein the entered order is transmitted from said third computer to said second computer.

31. The system of claim 29, further comprising:
a third computer, comprising at least a processor and a memory, in communication with said first computer,
wherein said third computer is operated by a custodian;
wherein said first computer transmits a confirmation of the order to said third computer.

32. The system of claim 29, wherein the confirmation includes at least information relating to the number of shares to which the order relates, information relating to the identity of the owner of such shares prior to the execution of such order, and information relating to the identity of the owner of such shares following the execution of such order.

33. The system of claim 28, wherein the exchange traded insurance fund is an actively managed fund.

34. A computer-readable medium having stored thereon computer-executable instructions for performing the steps comprising:
(a) receiving an order to trade in shares of an exchange traded insurance fund from an authorized agent through an ETIF portal;
(b) matching the order with a corresponding order;
(c) determining a price with respect to the order; and
(d) providing a confirmation to the authorized agent with respect to the order,
wherein if the order received in step (a) is an order to purchase shares, the corresponding order in step (b) is an order to sell shares;
wherein if the order received in step (a) is an order to sell shares, the corresponding order in step (b) is an order to purchase shares; and
wherein the confirmation comprises at least the price determined in step (c).

35. The computer-readable medium of claim 34, wherein the exchange traded insurance fund is an index fund.

36. The computer-readable medium of claim 34, wherein the exchange traded insurance fund is an actively managed fund.

37. A method of facilitating the sale of shares of exchange traded insurance funds, comprising:
(a) if the per share net asset value of an exchange traded insurance fund is a predetermined amount greater than the price at which it is trading on an exchange, purchasing shares of the exchange traded insurance fund from third parties and redeeming the purchased shares for the proportional share of the underlying assets of the exchange traded insurance fund represented by the redeemed shares; and
(b) if the per share net asset value of an exchange traded insurance fund is a predetermined amount less than the price at which it is trading on an exchange, contributing assets identical to the proportional share of the underlying assets of the exchange traded insurance fund represented by a number of shares in exchange for that number of shares of the exchange traded insurance fund and selling shares of the exchange traded insurance fund to third parties.

38. The method of claim 37, wherein the exchange traded insurance fund is an index fund.

39. The method of claim 37, wherein the predetermined amount in step (a) is zero.

40. The method of claim 37, wherein the predetermined amount in step (a) is greater than zero.

41. The method of claim 37, wherein the predetermined amount in step (b) is zero.

42. The method of claim 37, wherein the predetermined amount in step (b) is greater than zero.

43. The method of claim 37, wherein the number of shares redeemed in step (a) is equal to the number of shares in one creation lot multiplied by an integer equal to or greater than one.

44. The method of claim 37, wherein the number of shares received in exchange for the contributed assets in step (b) is equal to the number of shares in one creation lot multiplied by an integer equal to or greater than one.

45. The method of claim 37, wherein steps (a) and (b) are performed by a specialist.

46. The method of claim 37, wherein steps (a) and (b) are performed by a marketmaker.

47. The method of claim 37, wherein steps (a) and (b) are performed by a registered trader.

48. The method of claim 37, wherein steps (a) and (b) are performed by one or more of a specialist, a marketmaker, and one or more registered traders.

49. The method of claim 37, wherein the exchange traded insurance fund is an actively managed fund.

50. A method of facilitating the sale of shares of exchange traded insurance funds, comprising:
(a) prompting a qualified customer to submit an order to trade in units of an exchange traded insurance fund;
(b) transmitting an order to trade in shares of an exchange traded insurance fund relating to the order received in response to step (a) to an exchange through a portal;
(c) receiving a confirmation from the exchange if the order results in a trade; and
(d) providing information based on at least part of the information included in the confirmation to the qualified customer.

51. The method of claim 50, wherein the exchange traded insurance fund is an index fund.

52. The method of claim 51, further comprising:
(e) verifying that the qualified customer is a qualified customer.

53. The method of claim 50, wherein the exchange traded insurance fund is an actively managed fund.

54. A method of facilitating the sale of shares of exchange traded insurance funds, comprising steps for:
(a) transmitting an order to trade in shares of an exchange traded insurance fund received from a qualified customer to an exchange; and
(b) providing a confirmation relating to the order to the qualified customer.

55. The method of claim 54, wherein the exchange traded insurance fund is an index fund.

56. The method of claim 54, wherein the exchange traded insurance fund is an actively managed fund.

57. A system for facilitating the sale of shares of exchange traded insurance funds, comprising:
means for prompting a qualified customer to submit an order to trade in shares of an exchange traded insurance fund;
means for transmitting a received order to an exchange through a portal;
means for receiving a confirmation from the exchange if the order results in a trade; and
means for providing information based on at least part of the information included in the confirmation to the qualified customer.

58. The system of claim 57, wherein the exchange traded insurance fund is an index fund.

59. The system of claim 57, wherein the exchange traded insurance fund is an actively managed fund.

60. A computer-readable medium having stored thereon computer-executable instructions for performing the steps comprising:
(a) prompting a qualified customer to submit an order to trade in shares of an exchange traded insurance fund;
(b) transmitting an order received in response to step (a) to an exchange through a portal;
(c) receiving a confirmation from the exchange if the order results in a trade; and
(d) providing information based on at least part of the information included in the confirmation to the qualified customer.

61. The computer-readable medium of claim 60, wherein the exchange traded insurance fund is an index fund.

62. The computer-readable medium of claim 60, wherein the exchange traded insurance fund is an actively managed fund.

63. A system for facilitating the sale of shares of exchange traded insurance funds, comprising:
a first computer, comprising at least a processor and a memory;
a second computer, comprising at least a processor and a memory, in communication with said first computer; and
a third computer, comprising at least a processor, a display, and an input device, in communication with said second computer,
wherein said second computer is operated by an authorized agent;
wherein said third computer is operated by a qualified customer;
wherein a qualified customer is prompted to submit an order to trade in shares of an exchange traded insurance fund into said third computer;
wherein the order is transmitted from said third computer to said second computer;
wherein the order is transmitted from said second computer to said first computer;
wherein said first computer transmits a confirmation to said second computer if the order results in a trade; and
wherein said second computer transmits to said third computer information based on at least part of the information included in the confirmation.

64. The system of claim 63, wherein the exchange traded insurance fund is an index fund.

65. The system of claim 63, wherein the exchange traded insurance fund is an actively managed fund.

66. A method of facilitating the sale of shares of exchange traded insurance funds, comprising:
(a) prompting a customer to purchase a customer controlled insurance product;
(b) prompting a customer to trade in shares of at least one exchange traded insurance fund using funds in a customer controlled insurance product;
(c) providing an order received from a customer to trade in shares of an exchange traded insurance fund to at least one of a broker, a portal, an exchange, or a specialist; and
(d) providing a statement relating to the customer controlled insurance product to the customer.

67. The method of claim 66, wherein the exchange traded insurance fund is an index fund.

68. The method of claim 66, wherein the exchange traded insurance fund is an actively managed fund.

69. A method of facilitating the sale of shares of exchange traded insurance funds, comprising steps for:
(a) receiving an order to trade in shares of at least one exchange traded insurance fund using funds in a customer controlled insurance product;
(b) providing an order received from a customer to trade in shares of an exchange traded insurance fund to at least one of a broker, a portal, an exchange, or a specialist; and
(c) providing a statement relating to the customer controlled insurance product to the customer.

70. The method of claim 69, wherein the exchange traded insurance fund is an index fund.

71. The method of claim 69, wherein the exchange traded insurance fund is an actively managed fund.

72. A computer-readable medium having stored thereon computer-executable instructions for performing the steps comprising:
(a) prompting a customer to purchase a customer controlled insurance product;
(b) prompting a customer to trade in shares of at least one exchange traded insurance fund using funds in a customer controlled insurance product;
(c) providing an order received from a customer to trade in shares of an exchange traded insurance fund to at least one of a broker, a portal, an exchange, or a specialist; and
(d) providing a statement relating to the customer controlled insurance product to the customer.

73. The computer-readable medium of claim 72, wherein the exchange traded insurance fund is an index fund.

74. The computer-readable medium of claim 72, wherein the exchange traded insurance fund is an actively managed fund.

75. A system for facilitating the sale of shares of exchange traded insurance funds, comprising:
means for prompting a customer to purchase a customer controlled insurance product;
means for prompting a customer to trade in shares of at least one exchange traded insurance fund using funds in a customer controlled insurance product;
means for providing an order received from a customer to trade in shares of an exchange traded insurance fund to at least one of a broker, a portal, an exchange, or a specialist; and
means for providing a statement relating to the customer controlled insurance product to the customer.

76. The system of claim 75, wherein the exchange traded insurance fund is an index fund.

77. The system of claim 75, wherein the exchange traded insurance fund is an actively managed fund.

78. A system for facilitating the sale of shares of exchange traded insurance funds, comprising:
a first computer, comprising at least a processor and a memory;
a second computer, comprising at least a processor and a memory, in communication with said first computer; and
a third computer, comprising at least a processor, a display, and an input device, in communication with said second computer,
wherein a customer is prompted to purchase a customer controlled insurance product;
wherein said third computer is operated by a customer;
wherein a customer is prompted to enter into said third computer an order to trade in shares of at least one exchange traded insurance fund using funds in a customer controlled insurance product;
wherein the order is transmitted from said third computer to said second computer;
wherein said second computer is operated by an insurer;
wherein the received order is transmitted to said first computer;
wherein said first computer is operated by one of a broker, a portal, an exchange, or a specialist; and
wherein a statement relating to the customer controlled insurance product is transmitted to said third computer.

79. The system of claim 78, wherein the exchange traded insurance fund is an index fund.

80. The system of claim 78, wherein the exchange traded insurance fund is an actively managed fund.

81. A method of operating a virtual private exchange within a public exchange, comprising:
(a) receiving orders through a predetermined portal from authorized agents to engage in transactions involving a predetermined type of security;
(b) matching received orders with corresponding orders;
(c) executing matched orders; and
(d) sending confirmations of executed orders to authorized agents.

82. The method of claim 81, wherein the exchange traded insurance fund is an index fund.

83. The method of claim 81, wherein the exchange traded insurance fund is an actively managed fund.

84. A computer-readable medium having stored thereon a data structure relating to an order to trade in shares of an exchange traded insurance fund, comprising:
an attribute relating to the identity of an exchange traded insurance fund;
an attribute relating to the number of shares of the exchange traded insurance fund to be traded; and
an attribute relating to the type of trade.

85. The computer-readable medium of claim 84, wherein the exchange traded insurance fund is an index fund.

86. The computer-readable medium of claim 84, wherein the attribute relating to the identity of an exchange traded insurance fund comprises a CUSIP number.

87. The computer-readable medium of claim 84, wherein the attribute relating to the identity of an exchange traded insurance fund comprises the name of the exchange traded insurance fund.

88. The computer readable medium of claim 85, further comprising:
an attribute relating to the identity of an authorized agent.

89. The computer readable medium of claim 85, further comprising:
an attribute relating to the identity of a qualified customer.

90. The computer readable medium of claim 85, further comprising:
an attribute relating to the identity of an insurer.

91. The computer readable medium of claim 85, further comprising:
an attribute relating to the identity of an account of an insurer.

92. The computer readable medium of claim 85, further comprising:
an attribute relating to the identity of a sub-account of an insurer.

93. The computer readable medium of claim 85, further comprising:
an attribute relating to the compensation received by an authorized agent.

94. The computer readable medium of claim 85, further comprising:
an attribute relating to the compensation received by a broker.

95. The computer readable medium of claim 85, further comprising:
an attribute relating to a commission paid with respect to the order.

96. The computer readable medium of claim 85, further comprising:
an attribute relating to a spread relating to the order.

97. The computer readable medium of claim 85, further comprising:
an attribute relating to the identity of an account of a qualified customer.

98. The computer readable medium of claim 85, further comprising:
an attribute relating to the identity of a customer controlled insurance product.

99. The computer readable medium of claim 85, further comprising:
an attribute relating to the date and time of the order.

100. The computer readable medium of claim 85, wherein the data structure comprises an object.

101. The computer readable medium of claim 85, wherein the data structure comprises a database record.

102. The computer readable medium of claim 85, wherein the data structure comprises a record in a flat file.

103. The computer-readable medium of claim 84, wherein the exchange traded insurance fund is an actively managed fund.

104. A computer-readable medium having stored thereon a data structure relating to a confirmation relating to a transaction in shares of an exchange traded insurance fund, comprising:
an attribute relating to the identity of an exchange traded insurance fund;
an attribute relating to a number of shares of the exchange traded insurance fund involved in the transaction; and
an attribute relating to the type of transaction.

105. The computer-readable medium of claim 104, wherein the exchange traded insurance fund is an index fund.

106. The computer readable medium of claim 105, further comprising:
an attribute relating to the identity of an authorized agent.

107. The computer readable medium of claim 105, further comprising:
an attribute relating to the identity of a qualified customer.

108. The computer readable medium of claim 105, further comprising:
an attribute relating to the identity of an insurer.

109. The computer readable medium of claim 105, further comprising:
an attribute relating to the identity of an account of a qualified customer.

110. The computer readable medium of claim 105, further comprising:
an attribute relating to the identity of a customer controlled insurance product.

111. The computer readable medium of claim 105, further comprising:
an attribute relating to the price of the exchange traded insurance fund in the transaction.

112. The computer readable medium of claim 105, further comprising:
an attribute relating to the capacity in which a broker has acted.

113. The computer readable medium of claim 105, further comprising:
an attribute relating to any compensation received with respect to the trade by a broker.

114. The computer readable medium of claim 105, wherein the data structure comprises an object.

115. The computer readable medium of claim 105, wherein the data structure comprises a database record.

116. The computer readable medium of claim 105, wherein the data structure comprises a record in a flat file.

117. The computer-readable medium of claim 104, wherein the exchange traded insurance fund is an actively managed fund.

118. A method of facilitating the sale of shares of exchange traded insurance funds, comprising:
(a) receiving an order to purchase units in an exchange traded insurance fund from a qualified customer;
(b) purchasing shares in the exchange traded insurance fund on behalf of the qualified customer;
(c) periodically selling shares held on behalf of the qualified customer to meet expenses relating to the exchange traded insurance fund; and
(d) adjusting the unit/share ratio in response to each sale in step (c),
wherein the number of shares purchased in step (b) is determined based on a unit/share ratio in effect at the time of receipt of the order.

119. The method of claim 118, wherein the exchange traded insurance fund is an index fund.

120. The method of claim 119, wherein the expenses comprise mortality charges.

121. The method of claim 119, wherein the expenses comprise expenses relating to an insurance product.

122. The method of claim 119, wherein the expenses comprise expenses relating to the investment of assets held in an insurance product.

123. The method of claim 118, wherein the exchange traded insurance fund is an actively managed fund.
